(19) United States
(12) Patent Application Publication
(10) Pub. No.: US 2014/0132404 A1
(43) Pub. Date: May 15, 2014

(54) PEDESTRIAN COLLISION DETECTION SYSTEM, PEDESTRIAN COLLISION NOTIFICATION SYSTEM, AND VEHICLE COLLISION DETECTION SYSTEM

(71) Applicant: DENSO CORPORATION, Kariya-city (JP)

(72) Inventors: Yasutoshi Katoh, Kakegwa-city (JP); Akihito Tanahashi, Gifu-city (JP)

(73) Assignee: DENSO CORPORATION, Kariya-city (JP)

(21) Appl. No.: 14/077,622

(22) Filed: Nov. 12, 2013

(30) Foreign Application Priority Data
Nov. 14, 2012 (JP) 2012-250424

(51) Int. Cl. B60Q 9/00

(52) U.S. Cl. CPC B60Q 9/00
USPC 340/436

(57) ABSTRACT

In a pedestrian collision detection system, a mobile communication device is owned by a pedestrian, and a pedestrian collision detection device is disposed in a vehicle. A mobile-side impact detection part detects a collision between the vehicle and the pedestrian. A short-distance communication part enables wireless communication within a predetermined range. A vehicle-side collision detection part detects the collision. A wireless communication part enables wireless communication within a predetermined range. The wireless communication part and the short-distance communication part perform mutual authentication through pairing when the vehicle-side collision detection part detects the collision and a result of the detection is held by an impact record part. The pedestrian collision detection device includes a vehicle-side collision determination part configured to determine that the vehicle and the pedestrian have collided when the mutual authentication through pairing is satisfied between the wireless communication part and the short-distance communication part.

### CROSS REFERENCE TO RELATED APPLICATION

This application is based on Japanese Patent Application No. 2012-250424 filed on Nov. 14, 2012, the disclosure of which is incorporated herein by reference.

### TECHNICAL FIELD

The present disclosure relates to a pedestrian collision detection system that detects a collision between a vehicle and a pedestrian, and to a vehicle collision detection system that detects a collision between vehicles.

### BACKGROUND

Recently, there is developed a pedestrian collision detection system that activates a pedestrian protective device, such as an active hood for detecting a collision between a vehicle and a pedestrian to flip up a bonnet (hood) of a vehicle, or an air bag for pedestrian protection. In this case, the means for detecting a collision between a vehicles and a pedestrian is realized by, for example, a gravity sensor (G-sensor) or a chamber-type pressure sensor.

As described in JP-A-2002-032886, for example, there is also developed a notification system in which, if a pedestrian encounters some traffic impediment, a mobile phone of the pedestrian detects its impact gravity (G) and notifies a public institution about his/her personal information and the impediment situation.

However, in the case of the above “mobile traffic impediment notification terminal” in JP-A-2002-032886, it is difficult to distinguish and determine whether the impact G detected by the mobile phone is due to a collision with a vehicle or simply because the mobile phone is dropped. Furthermore, mistaken notification through such an irresponsible determination, and a request for emergency support by a public institution (e.g., medical institution or vehicle management center) need to be strictly limited. In addition, for a known system as an urgent notification system at the time of collision between a vehicles and a pedestrian, there is a system whereby, the distinction whether an obstacle with which the vehicle collides is a pedestrian or object is based on determination by a driver of the vehicle, and with the operation of a switch for urgent notification being permitted when the collision is detected by a collision detection means, whether the collision should be notified or not is left up to the determination by the vehicle driver; or a system whereby a possibility of a collision accident with a pedestrian is transmitted to an urgent notification center based on an output from a vehicle body impact sensor or when a pop-up hood of a vehicle is activated because of collision. Additionally, for example, there is known a system in which an image ahead of the vehicle by an image sensor is also transmitted to the urgent notification center at the same time, to make the urgent notification center determine whether such a collision accident is a human accident or physical accident.

As described above, it is difficult for the conventional technology to distinguish and determine whether an obstacle with which a vehicle collides is a pedestrian or object.

In addition to the case where the collision occurs between a vehicle and a pedestrian, in an event where the vehicle collides with another vehicle, there may be a need to automatically discern and identify this counterpart vehicle concerned in the accident. For example, this is a case of an accident where the vehicle is in a halt condition (e.g., parked or stopped state) and is collided with another vehicle. In such a case, this may be a hit-and-run (wrecking the vehicle) accident if a driver is away, from the stopped vehicle. If the fact that “the vehicle has been collided with another vehicle” can be detected on the stopped vehicle side to identify the counterpart vehicle, the user of the damaged vehicle will not be compelled to accept the collision to take the accident lying down.

### SUMMARY

The present disclosure addresses at least one of the above issues.

According to the present disclosure, there is provided a pedestrian collision detection system including a mobile communication device and a pedestrian collision detection device. The mobile communication device is owned by a pedestrian and includes a mobile-side impact detection part, an impact record part, and a short distance communication part. The mobile-side impact detection part is configured to detect a collision between a vehicle and the pedestrian. The impact record part is configured to, when the mobile-side impact detection part detects the collision, hold a result of the detection for a predetermined time. The short distance communication part is configured to enable wireless communication within a predetermined range. The pedestrian collision detection device is disposed in the vehicle and includes a vehicle-side collision detection part and a wireless communication part. The vehicle-side collision detection part is configured to detect the collision between the vehicle and the pedestrian, or a crash between the vehicle and an object. The wireless communication part is configured to enable wireless communication within a predetermined range. The wireless communication part and the short distance communication part perform mutual authentication through pairing when the vehicle-side collision detection part detects the collision and the result of the detection is held by the impact record part. The pedestrian collision detection device further includes a vehicle-side collision determination part configured to determine that the vehicle and the pedestrian have collided when the mutual authentication through pairing is satisfied between the wireless communication part and the short distance communication part.

According to the present disclosure, there is also provided a pedestrian collision notification system including a mobile communication device and a pedestrian collision detection device. The mobile communication device is owned by a pedestrian and includes a mobile-side impact detection part, an impact record part, and a short distance communication part. The mobile-side impact detection part is configured to detect a collision between a vehicle and the pedestrian. The impact record part is configured to, when the mobile-side impact detection part detects the collision, hold a result of the detection for a predetermined time. The short distance communication part is configured to enable wireless communication within a predetermined range. The pedestrian collision detection device is disposed in the vehicle and includes a vehicle-side collision detection part and a wireless communication part. The vehicle-side collision detection part is configured to detect the collision between the vehicle and the pedestrian, or a crash between the vehicle and an object. The wireless communication part is configured to enable wireless communication within a predetermined range. The wireless communication part and the short distance communication part perform mutual authentication through pairing when the vehicle-side collision detection part detects the collision and the result of the detection is held by the impact record part. The pedestrian collision detection device further includes a vehicle-side collision determination part and a notification part. The vehicle-side collision determination part is configured to determine that the vehicle and the pedestrian have collided when the mutual authentication through pairing is satisfied between the wireless communication part and the short distance communication part. The notification part is configured to notify a public institution about the collision when the vehicle-side collision determination part determines that the vehicle and the pedestrian have collided.

In addition, according to the present disclosure, there is provided a vehicle collision detection system including a first collision detection device and a second collision detection device. The first collision detection device is disposed in a first vehicle and includes a first collision detection part and a first wireless communication part. The first collision detection part is configured to detect a collision. The first wireless communication part is configured to enable wireless communication within a predetermined range. The second collision detection device is disposed in a second vehicle and includes a second collision detection part and a second wireless communication part. The second collision detection part is configured to detect a collision. The second wireless communication part is configured to enable wireless communication within a predetermined range. The first wireless communication part and the second wireless communication part perform mutual authentication through pairing when the first collision detection part and the second collision detection part detect the collision. Each of the first collision detection device and the second collision detection device further includes a collision determination part that is configured to determine that the first vehicle and the second vehicle have collided with each other when the mutual authentication through pairing is satisfied between the first wireless communication part and the second wireless communication part.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a configuration of a pedestrian collision detection system in accordance with a first embodiment;

FIG. 2 is a diagram illustrating a short distance communication according to the first embodiment;

FIG. 3 is a flow chart illustrating a flow of control in the pedestrian collision detection system of the first embodiment;

FIG. 4 is a flow chart illustrating a flow of control in a pedestrian collision detection system in accordance with a second embodiment;

FIG. 5 is a diagram illustrating a configuration of a pedestrian collision detection device in accordance with a third embodiment;

FIG. 6 is a diagram illustrating a configuration of a vehicle collision detection system in accordance with a fourth embodiment;

FIG. 7 is a diagram illustrating collision detection according to the fourth embodiment; and

FIG. 8 is a flow chart illustrating a flow of control in the vehicle collision detection system of the fourth embodiment.

### DETAILED DESCRIPTION

Embodiments will be described below in reference to the drawings. For the same or equivalent component in the following embodiments, its corresponding reference numeral is used in the drawings. The drawings used for the description are conceptual diagrams.

### First Embodiment

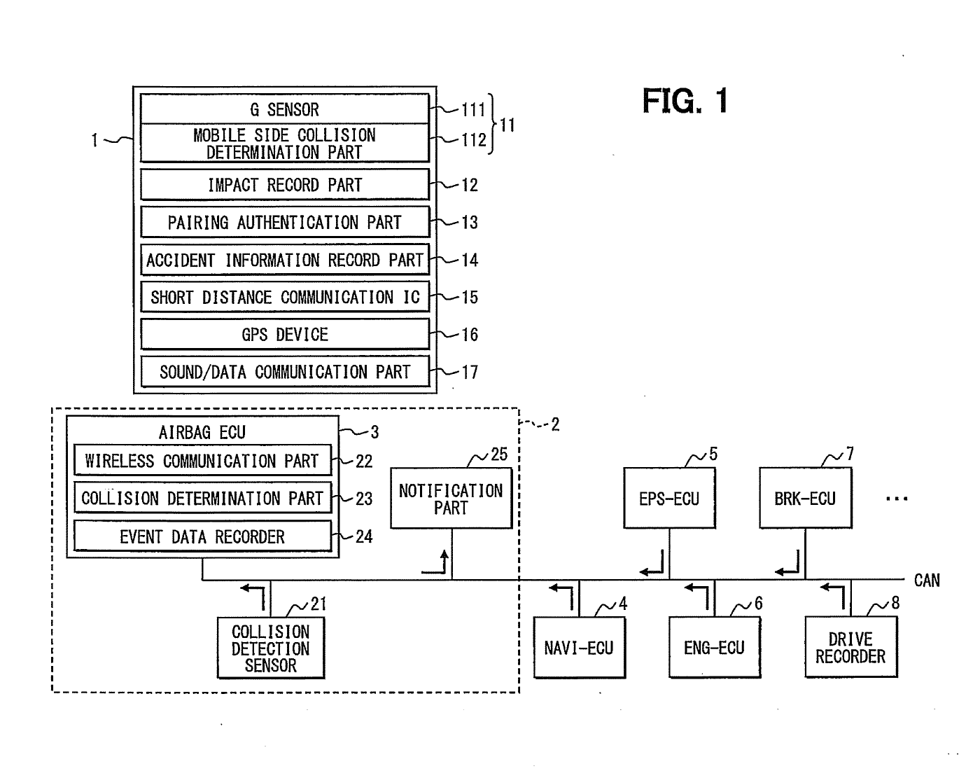

A pedestrian collision detection system (pedestrian collision notification system, pedestrian collision emergency call system) of a first embodiment is constituted of a mobile communication device 1 and a pedestrian collision detection device 2 as illustrated in FIG. 1. The mobile communication device 1 is a device that can be carried by a pedestrian and can have wireless communication with the outside, and includes an (mobile-side) impact detection part 11, an impact record part 12, a pairing authentication part 13, an accident information record part 14, a short distance communication integrated circuit (IC) (corresponding to a “short distance communication part”) 15, a global positioning system (GPS) device 16, and a sound/data communication part 17.

The mobile communication device 1 is a mobile terminal, such as a mobile phone, smartphone or tablet terminal including at least the short distance communication IC 15. The short distance communication IC 15 is a communication IC that enables wireless communication within a predetermined range using, for example, “Bluetooth” (registered trademark). The sound/data communication part 17 is a communication IC that enables long distance communication (at least one of telephone and data communication) with the outside.

The impact detection part 11 includes a G-sensor 111 and a mobile-side collision determination part 112. The G-sensor 111 is an acceleration sensor that is originally provided for the mobile communication device 1 for detecting upper and lower directions (top and bottom directions) of the mobile communication device 1. The mobile-side collision determination part 112 is an IC, and receives a result detected by the G-sensor 111 to determine that an owner (pedestrian) has collided with a vehicle when the measurement value by the G-sensor 111 exceeds a preset threshold value. If determining that there is the collision, the mobile-side collision determination part 112 transmits this information to the impact record part 12.

The impact record part 12 is a device that can hold information for a predetermined time, for example, a memory such as a random access memory (RAM) or a latch circuit. In the present embodiment, the impact record part 12 is a non-volatile memory that is originally disposed in the mobile communication device 1. Upon reception of collision detection information from the mobile-side collision determination part 112, the impact record part 12 records this information for a preset time (predetermined time). In the present embodiment, the mobile-side collision determination part 112 sets a detection flag at the impact record part 12, and deletes this detection flag after the predetermined time. The information recorded in the impact record part 12 may be an event associated with an impact such as a value of impact G.

The pairing authentication part 13 is a device (IC) for pairing (mutual recognition/authentication through communication) with an external communication device. When the short distance communication IC 15 receives a pairing request signal as well as when the detection flag is set at the impact record part 12, the pairing authentication part 13 transmits a pairing response signal via the short distance communication IC 15 to the origin of the pairing request signal. More specifically, upon receiving the pairing request signal, the pairing authentication part 13 confirms whether or not the detection flag is set at the impact record part 12, and transmits the pairing response signal through the communication IC when there is the detection flag. The pairing response signal may be any signal as long as it is a signal that conveys the authentication of the origin of the pairing request signal to this origin. Accordingly, the mutual recognition (authentication) is completed so that information exchange, can be made with an object whose authentication is satisfied through the pairing. The pairing authentication part 13 transmits unique information (e.g., telephone number and owner name) of the mobile communication device 1 via the communication IC along with the pairing response signal or after the pairing response signal.

The accident information record part 14 is a non-volatile memory. The impact record part 12 may be included in the accident information record part 14. The accident information record part 14 records unique information (e.g., vehicle number or driver information) exchanged with the vehicle through the pairing. Functions (e.g., collision determination, information recording, pairing) of the mobile communication device 1 as described above may be executed by an application software that operates in the smartphone.

The pedestrian collision detection device 2 is disposed in the vehicle, and is a device that detects a collision between a vehicle and a pedestrian. The pedestrian collision detection device 2 is used mainly for operation control of a pedestrian protective device (not shown) such as an active hood that flips up a bonnet (hood), and for automatic notification control. In the present embodiment, an air bag electronic control unit (ECU) 3 also performs the pedestrian collision detection and control of deployment of the pedestrian protective device together with control of deployment of an air bag (not shown).

Specifically, the pedestrian collision detection device 2 includes a collision detection sensor (corresponding to a “vehicle-side collision detection part”) 21, a wireless communication part 22, a (vehicle-side) collision determination part 23, an event data recorder 24, and a notification part (emergency call part) 25. The collision detection sensor 21 is, for example, a G-sensor or pressure sensor, and is a sensor that detects a collision between a vehicle and a pedestrian based on a measurement value. In the present embodiment, the collision detection sensor 21 is a chamber-type pressure sensor that detects its collision with a pedestrian based on a pressure change because of deformation of a chamber (not shown) provided for a front part of the vehicle.

When the measurement value exceeds a threshold value, the collision detection sensor 21 detects that the vehicle collides with a pedestrian or object, and transmits the detection result to the air bag ECU 3. In accordance with reception of this detection result, the air bag ECU 3 deploys the pedestrian protective device.

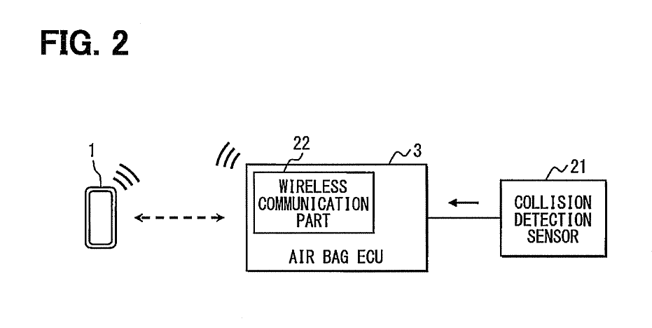

The wireless communication part 22 is a short distance communication device or communication IC that can have wireless communication with the outside within a predetermined range. In the present embodiment, the wireless communication part 22 is a communication IC, and is disposed in the air bag ECU 3 as illustrated in FIG. 2. The wireless communication part 22 may be arranged at other positions than the air bag ECU 3. Nevertheless, the communication part 22 can be disposed in the air bag ECU 3 in the light of speed of response.

Upon reception of the detection result from the collision detection sensor 21, the air bag ECU 3 makes the wireless communication part 22 transmit the pairing request signal. Specifically, when the collision detection sensor 21 detects a collision, the wireless communication part 22 transmits the pairing request signal within a predetermined range. When the wireless communication part 22 receives the pairing response signal for the pairing request signal, the collision determination part 23 recognizes that authentication by the pairing with the outside (mobile communication device 1) has been satisfied.

The collision determination part 23 is an IC disposed in the air bag ECU 3 and, if recognizing the satisfaction of authentication by the pairing, determines that an object of the collision which is detected by the collision detection sensor 21 is a pedestrian. In the case of its determination that the colliding object is a pedestrian, the collision determination part 23 transmits instructions to collect information on the accident, and transmits notification (emergency call) instructions to the notification part 25.

The event data recorder 24 is a non-volatile memory disposed in the air bag ECU 3, and records the unique information (e.g., telephone number or owner name) of the mobile communication device 1 which is obtained through the pairing. The accident information about situations before and after the collision detected by the collision detection sensor 21 is recorded in the event data recorder 24. The accident information includes positional information on the own vehicle from a navigation ECU (corresponding to a “vehicle-side position information acquisition part”) 4, rudder angle information from an electric power steering ECU 5, vehicle speed information from an engine ECU 6, brake information from a brake ECU 7, and images before or after the collision from a drive recorder 8. The event data recorder 24 may be set to record at least one of the above various kinds of data. The accident information is concerning the situations before and after the collision, and may include at least information immediately before the collision.

The notification part 25 is a wireless device (communication module) that is provided separately from the air bag ECU 3 and is capable of wireless long distance communication (e.g., telephone or data communication). Upon reception of the notification instructions from the collision determination part 23, the notification part 25 automatically notifies a public institution (medical institution or vehicle management center) about the collision with a pedestrian. The notification may be by means of data alone or a preset sound. Along with the notification of the collision, the notification part 25 transmits to the public institution the unique information and accident information about the mobile communication device 1 and the vehicle which are recorded in the event data recorder 24. In addition, the medical institution is, for example, a hospital or fire department (119). The vehicle management center may be, for example, facilities where various kinds of automakers provide service. The communication in the vehicle is carried out through control area network (CAN) communication.

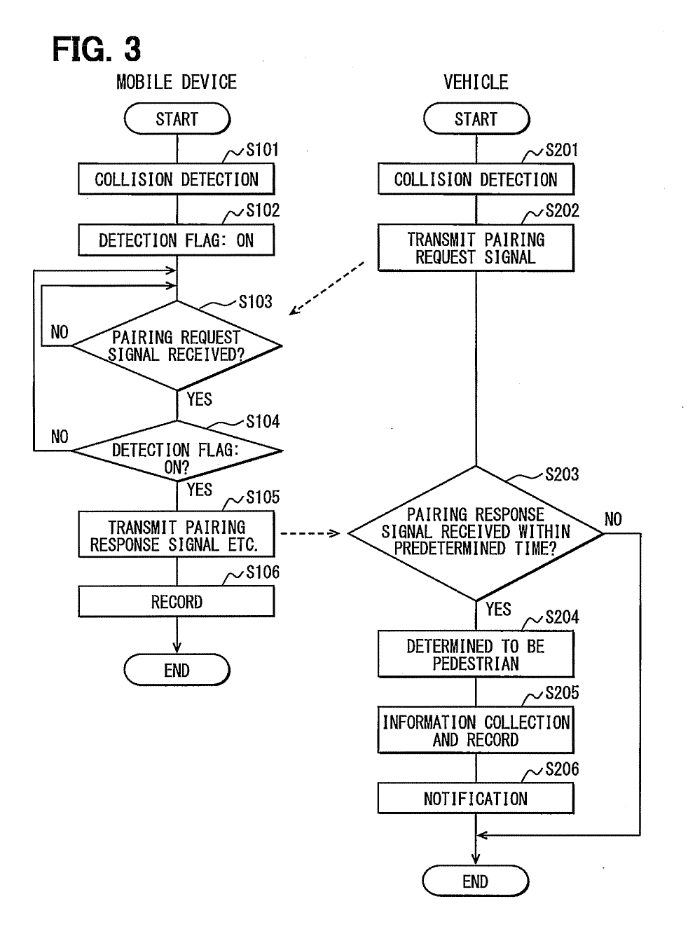

A flow of control of the pedestrian collision detection system of the first embodiment will be described. As illustrated in FIG. 3, in the case of occurrence of the collision between the vehicle in which the pedestrian collision detection device 2 is disposed, and the pedestrian carrying the mobile communication device 1, the collision is detected (S101) on the mobile communication device 1-side as a result of the measurement value by the G-sensor 111 of the mobile communication device 1 exceeding the threshold value; and the collision is detected (S201) also on the vehicle-side as a result of the measurement value by the collision detection sensor 21 in the vehicle exceeding the threshold value. In the mobile communication device 1, the detection flag is set at the impact record part 12 (detection flag: ON) because of the detection of the collision (S102).

Next, the wireless communication part 22 transmits the pairing request signal within a predetermined range on the vehicle-side (S202). The pairing request signal may be sent continuously until the communication part 22 receives the pairing response signal in a predetermined time (period) immediately after the collision detection, or may be sent through a stand-by time after the collision detection. In the present embodiment, the former is employed. When the mobile communication device 1 receives the pairing request signal through the short distance communication (S103: Yes), the pairing authentication part 13 determines whether the detection flag is set at the impact record part 12 (S104).

If the detection flag is set (S104: Yes), the pairing authentication part 13 transmits the unique information (e.g., telephone number or owner name) of the mobile communication device 1 together with the pairing response signal to the vehicle-side (wireless communication part 22) (S105). On the other hand, if the detection flag is not set (S104: No), the mobile communication device 1 does not perform the pairing.

If the wireless communication part 22 receives the pairing response signal within a predetermined time (S203: Yes), the collision determination part 23 determines that the collision is a “collision with a pedestrian” (S204). If the wireless communication part 22 does not receive the pairing response signal within a predetermined time (S203: No), control ends the processing.

If the collision determination part 23 determines that the collision is a collision with a pedestrian, the accident information is collected by the collision determination part 23 (air bag ECU 3), and this accident information is recorded on the event data recorder 24 (S205). As described above, the accident information includes, for example, a position of an accident occurrence site, images before and after the accident occurrence, a collision position of a bumper and a rate of acceleration at the time of the collision, a vehicle speed, a braking signal, a steering angle signal, and a telephone number of the pedestrian's mobile communication device 1. Then, the notification part 25 notifies the public institution of the accident along with the accident information (S206).

In a case where the wireless communication part 22 transmits the unique information (e.g., vehicle number or driver information) of the vehicle together with the pairing request signal, or in a case where the communication part 22 transmits the unique information of the vehicle after the mutual recognition, this unique information is recorded on the accident information record part 14 of the mobile communication device 1 (S106). When the collision is detected at step 201, the pedestrian protective device is deployed.

In the pedestrian collision detection system of the first embodiment, through the mutual recognition with the mobile communication device 1 by the pairing immediately after the occurrence of the collision on the vehicle-side, it can be determined with high accuracy that the collision is a collision with a pedestrian. As a result of the highly-accurate determination of the collision with a pedestrian, a false report by automatic notification is limited.

In the present embodiment, the G-sensor 111 which is originally disposed in, for example, a mobile phone, smartphone, or tablet, is used for detecting the impact. Accordingly, the system has an advantage in that a dedicated sensor for impact detection is not necessary to eliminate extra costs. Furthermore, in the present embodiment, the unique information of the mobile communication device 1 can be acquired through the mutual recognition by the pairing. Accordingly, the public institution can be notified also about the information on the pedestrian with whom the vehicle has collided at the time of notification by the notification part 25. As a result, a personal identification, for example, can be easily made. In addition, the notification part 25 notifies the collected accident information at the same time. Consequently, a prompt and accurate assessment of the situation by the public institution, which has been notified, is made possible to enable prompt relief activities and their preparation in accordance with the accident situation.

### Second Embodiment

A pedestrian collision detection system (pedestrian collision notification system) of a second embodiment is configured similarly to the first embodiment, and has a different flow of control. Thus, only the flow of control will be described below.

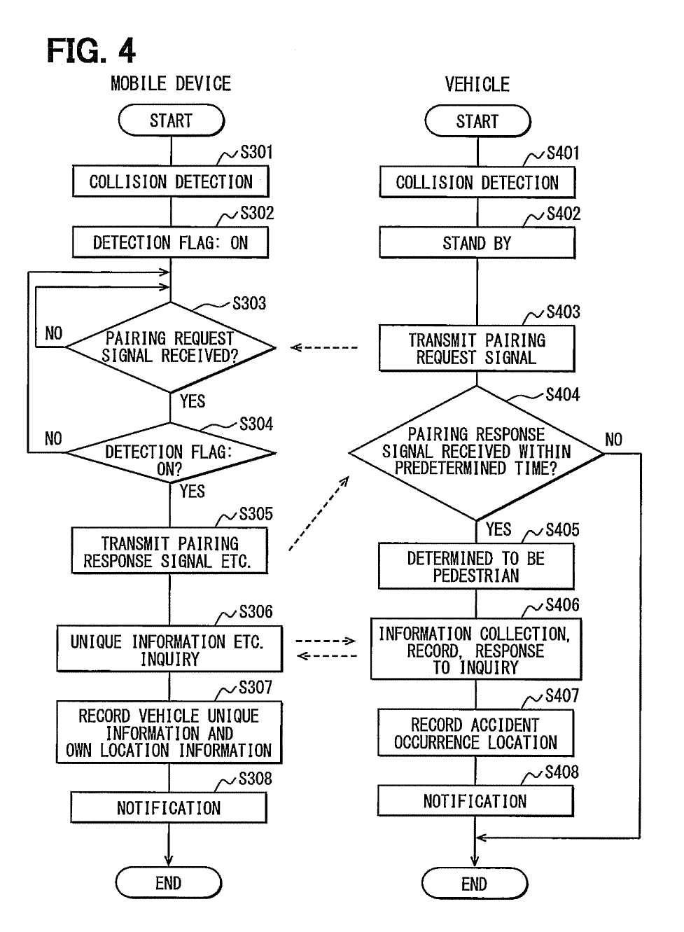

As illustrated in FIG. 4, when an impact detection part 11 of a mobile communication device 1 detects a collision (S301), a detection flag is set at an impact record part 12 for a predetermined time (S302). On the vehicle-side, when a collision detection sensor 21 detects the collision (S401), after standing by for a predetermined time (approximately 1 second) (S402), a wireless communication part 22 sends a pairing request signal (S403). The pairing request signal may be transmitted continuously within a predetermined time.

When the mobile communication device 1 receives the pairing request signal (S303: Yes), a pairing authentication part 13 determines whether or not the detection flag is set (S304). If the detection flag is set (S304: Yes), the mobile communication device 1 transmits a pairing response signal (S305). In this case, the mobile communication device 1 transmits its own unique information.

The unique information includes positional information on the mobile communication device 1. This positional information is position information obtained by a GPS device (corresponding to a “mobile-side position information acquisition part”) 16 disposed in the mobile communication device 1. Additionally, the unique information such as position information may be transmitted after the pairing response signal is transmitted, for example, after an inquiry from the vehicle. When the wireless communication part 22 receives the pairing response signal (S404: Yes), a collision determination part 23 determines that the vehicle collides with a pedestrian (S405).

After transmitting the pairing response signal, the pairing authentication part 13 of the mobile communication device 1 transmits an inquiry signal (information request signal) for the unique information to the vehicle (S306). Upon reception of the inquiry signal, the wireless communication part 22 transmits the unique information (e.g., vehicle number or driver information) of the vehicle to the mobile communication device 1 (S406). An accident information record part 14 records the received unique information of the vehicle (S307). Moreover, the accident information record part 14 also records the position information at the time of the collision that is obtained by the GPS device 16 (S307).

When the collision determination part 23 determines that the vehicle collides with the pedestrian (S405), the accident information is collected by the collision determination part 23, and the accident information and the unique information (e.g., telephone number or owner name) of the mobile communication device 1 are recorded on an event data recorder 24 (S406).

Subsequently, the event data recorder 24 records an accident occurrence location (S407) determined based on the position information of the mobile communication device 1 at the time of the collision that is obtained from the mobile communication device 1, and position information of the vehicle at the time of the collision that is obtained from a navigation ECU 4. Specifically, based on the position information of the mobile communication device 1 and the position information of the vehicle which are recorded on the event data recorder 24, an air bag ECU 3 identifies the accident occurrence location and records the location on the event data recorder 24. The accident occurrence location may be determined to be a point where the position of the mobile communication device 1 and the position of the vehicle coincide with each other; or a central point between both the positions. Alternatively, the accident occurrence location may be determined to be both the two pieces of position information (i.e., two points).

Then, a notification part 25 notifies the public institution about the occurrence of the accident and the accident information recorded on the event data recorder 24 (S408). In addition, the mobile communication device 1 also notifies automatically the public institution such as a 119 call (S308) after completion of the pairing. The notification by the mobile communication device 1 may be by means of a sound registered beforehand, or data transmission. Furthermore, the mobile communication device 1 transmits data such as the position information recorded on the accident information record part 14 together with the notification, to the public institution.

In the pedestrian collision detection system (pedestrian collision notification system) of the second embodiment, similar to the first embodiment, the collision with the pedestrian can be accurately detected to limit a false report from the vehicle or the mobile communication device 1 to the public institution. In the second embodiment, the unique information of the vehicle is recorded also on the mobile communication device 1-side through the mutual recognition by the pairing. Accordingly, by also giving this unique information (e.g., vehicle number or driver information) of the vehicle to the public institution at the time of notification from the mobile communication device 1, smooth handling of the accident becomes possible. Additionally, also on the occurrence of a hit-run case in which, after a vehicle collides with a pedestrian, the vehicle leaves the spot of accident behind without rescuing the pedestrian, similarly, the mobile communication device 1 can use this unique information of the vehicle. As a result, such a case can be quickly handled.

### Third Embodiment

A pedestrian collision detection system of a third embodiment is different from the second embodiment in that the system includes a hit-and-run determination part. Therefore, only the different part will be described to omit description of the same configuration as the second embodiment using its corresponding reference numeral.

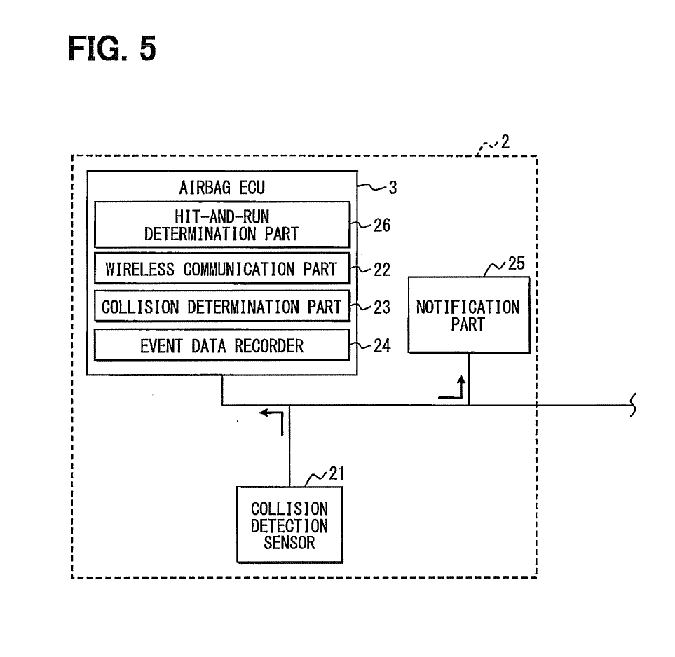

As illustrated in FIG. 5, a pedestrian collision detection device 2 includes a hit-and-run determination part 26 that is disposed in an air bag ECU 3 in addition to the configuration of the second embodiment. The hit-and-run determination part 26 determines that there is a possibility of a hit-and-run accident if a vehicle position indicated by position information which is obtained by a navigation ECU 4 is separated from an accident occurrence location recorded on an event data recorder 24 by a predetermined distance or longer within a predetermined time after a collision determination part 23 determines that a vehicle collides with a pedestrian.

As a result of this configuration, when the hit-and-run determination part 26 determines that there is a possibility of the hit-and-run accident, a driver of the vehicle can be alerted, such as the pedestrian collision detection device 2 turning on a warning lamp in the vehicle so that the hit-and-run accident can be limited. Moreover, when the hit-and-run determination part 26 determines that there is a possibility of the hit-and-run accident, a notification part 25 can notify the public institution.

With respect to a method of determining whether there is a possibility of the hit-and-run accident, the hit-and-run determination part 26 may employ methods other than the above. For example, the hit-and-run determination part 26 may be set to determine that there is a possibility of the hit-and-run accident, if communication cannot be made between a wireless communication part 22 and a mobile communication device 1 (i.e., in a state where a short distance communication cannot be made) within a predetermined time after the collision determination part 23 determines that the vehicle collides with the pedestrian. In this case as well, effects similar to the above are produced.

Modifications to the above embodiments will be described below. The present disclosure is not limited to the above embodiments. For example, the pairing request signal may be transmitted from the mobile communication device 1. More specifically, when the impact detection part 11 detects a collision, the mobile communication device 1 transmits the pairing request signal within a predetermined range through the short distance communication IC 15. Then, when the wireless communication part 22 receives the pairing request signal and in a state where the collision detection sensor 21 detects the collision, a result of this detection is recorded on the event data recorder 24, and the wireless communication part 22 transmits the pairing response signal to the mobile communication device 1. In this case as well, the mutual recognition by the pairing is carried out between the mobile communication device 1 and the wireless communication part 22. Through the transmission and reception of mutual unique information, similar effects to the above embodiments are produced.

Furthermore, in the above first to third embodiments, a pedestrian collision detecting function is also included in the air bag ECU 3. Alternatively, the function may be included in another ECU (control part) such as a pedestrian collision detection ECU or pedestrian protective ECU. Moreover, the impact detection part 11 may also be an acoustic sensor such as a microphone, instead of the device using the G-sensor 111.

In addition, the collision detection sensor 21 may also be a sensor for detecting an impact by means of a G-sensor or optical fiber, instead of a pressure sensor.

### Fourth Embodiment

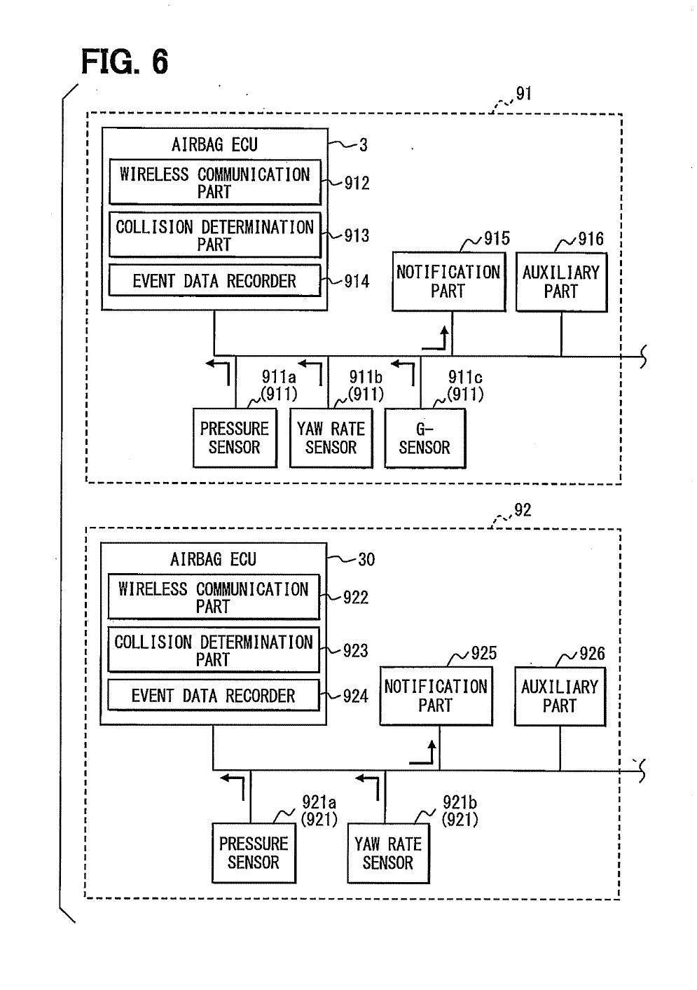

As illustrated in FIG. 6, a vehicle collision detection system in a fourth embodiment includes a first collision detection device 91 disposed in a first vehicle C1, and a second collision detection device 92 disposed in a second vehicle C2 which is different from the first vehicle C1. The first collision detection device 91 includes a collision detection sensor (corresponding to a “first collision detection part”) 911, a wireless communication part (corresponding to a “first wireless communication part”) 912, a collision determination part 913, an event data recorder 914, a notification part 915, and an auxiliary battery 916.

The collision detection sensor 911 is configured as, for example, a G-sensor or pressure sensor, and is a sensor for detecting a collision based on a measurement value. In the present embodiment, the collision detection sensor 911 includes a pressure sensor 911a, a G-sensor 911c, and a yaw rate sensor 911b. The pressure sensor 911a is a chamber-type pressure sensor for detecting a collision with a pedestrian based on a pressure change caused by deformation of a chamber (not shown) provided at a front part of the vehicle. The G-sensor is a sensor for detecting an impact on the vehicle, and the yaw rate sensor 911b is a sensor for detecting rotation of the vehicle with the vertical direction serving as an axis of the rotation.

The pressure sensor 911a, the G-sensor 911c, and the yaw rate sensor 911b detect a collision with something when a measurement value exceeds a threshold value to transmit a detection result to an airbag ECU 3. The pressure sensor 911a, the G-sensor 911c, and the yaw rate sensor 911b may be configured simply to transmit the measurement value to the airbag ECU 3, and in this case, the airbag ECU 3 determines whether the vehicle has collided with something based on the measurement value received by the airbag ECU 3.

The wireless communication part 912 is a short distance communication device or communication IC that can have wireless communication with the outside within a predetermined range. In the present embodiment, the wireless communication part 912 is a communication IC, and is disposed in the airbag ECU 3. The wireless communication part 912 may be arranged at other positions than the airbag ECU 3. Nevertheless, the communication part 912 can be disposed in the airbag ECU 3 in the light of speed of response.

Upon reception of the detection result from the collision detection sensor 911, the airbag ECU 3 makes the wireless communication part 912 transmit a pairing request signal. Specifically, when the collision detection sensor 911 detects a collision with something, the wireless communication part 912 transmits the pairing request signal within a predetermined time and predetermined range. In the present embodiment, in a case of the vehicle C1 being in a stopped state, when the airbag ECU 3 receives the detection results from both the pressure sensor 911a and the G-sensor 911c, and the yaw rate sensor 911b, the airbag ECU 3 sends a transmission command to the wireless communication part 912.

The same is true in a case where the vehicle C1 is not in a stopped state but in a traveling state conversely and the vehicle C1 collides with another vehicle in a stopped state. Thus, similarly, when the airbag ECU 3 receives the detection result from the pressure sensor 911a, the airbag ECU 3 sends a transmission command to the wireless communication part 912. In the present embodiment, the stopped state means a state in which ignition is turned off.

When the wireless communication part 912 receives a pairing response signal in response to the pairing request signal, the collision determination part 913 recognizes that authentication has been satisfied through the pairing with the outside (second collision detection device 92). Conversely, when the wireless communication part 912 receives the pairing request signal from the second collision detection device 92, the wireless communication part 912 transmits the pairing response signal to the outside if the airbag ECU 3 receives the detection result from the collision detection sensor 911. In the case of reception of the pairing request signal or pairing response signal within a predetermined time after the detection result is received from the collision detection sensor 911, the collision determination part 913 recognizes that authentication has been satisfied.

The collision determination part 913 is an IC disposed in the airbag ECU 3, and determines that an object for the collision detected by the collision detection sensor 911 is a vehicle if the part 913 recognizes that authentication has been satisfied through the pairing. When the collision determination part 913 determines that the object for the collision is a vehicle, the part 913 transmits instructions to collect information about the accident. Moreover, the collision determination part 913 transmits instructions of notification to the notification part 915. In a case of the vehicle C1 being in a traveling state, the collision determination part 913 in the present embodiment transmits the instructions of notification to the notification part 915 when the part 913 determines that the object for the collision is a vehicle and recognizes that authentication has been satisfied through the pairing.

The event data recorder 914 is a non-volatile memory disposed in the airbag ECU 3 and records unique information (e.g., vehicle number or driver information) on the second vehicle C2 obtained through the pairing. Furthermore, the accident information about before and after the collision detected by the collision detection sensor 911 is recorded on the event data recorder 914. The accident information includes the measurement value by a G-sensor disposed in, for example, the airbag ECU 3, a collided position (damaged position) specified by, for example, the pressure sensor 911a, positional information on the own vehicle from a navigation ECU 4, rudder angle information from an electric power steering ECU 5, vehicle speed information from an engine ECU 6, brake information from a brake ECU 7, and images before or after the collision from a drive recorder 8. The event data recorder 914 may be set to record at least one of the above various kinds of data. The accident information is concerning the situations before and after the collision, and may include at least information immediately before the collision. The notification part 915 is a wireless device (communication module) that is provided separately from the airbag ECU 3 and is capable of wireless long distance communication (e.g., telephone or data communication). Upon reception of the notification instructions from the collision determination part 913, the notification part 915 automatically notifies a vehicle management center (corresponding to a “public institution”) about the collision with the vehicle. The notification may be by means of data alone or a preset sound. Along with the notification of the collision, the notification part 915 transmits the unique information about the second vehicle C2, unique information about the first vehicle C1, and the accident information which are recorded on the event data recorder 914. The vehicle management center may be, for example, facilities where various kinds of automakers provide service.

The auxiliary battery 916 is a battery disposed separately from a main battery that is generally disposed in a vehicle. The auxiliary battery 916 is connected to various parts of the airbag ECU 3 and the first collision detection device 91. The auxiliary battery 916 supplies electricity to these various parts regardless of whether the ignition is turned on or off. The collision detection devices 91, 92 operate regardless of whether the ignition is turned on or off.

The second collision detection device 92 includes a collision detection sensor (corresponding to a “second collision detection part”) 921, a wireless communication part (corresponding to a “second wireless communication part”) 922, a collision determination part 923, an event data recorder 924, a notification part 925, and an auxiliary battery 926. The collision detection sensor 921 includes a pressure sensor 921a and a yaw rate sensor 921b. An airbag ECU 30 is disposed in the second vehicle C2, and the wireless communication part 922, the collision determination part 923, and the event data recorder 924 are arranged in the airbag ECU 30. Configuration of the second collision detection device 92 is the same configuration as the first collision detection device 91, so that its explanation will be omitted. The collision detection devices 91, 92 are connected to the parts 4 to 8 in their respective vehicles C1, C2, similar to the first embodiment.

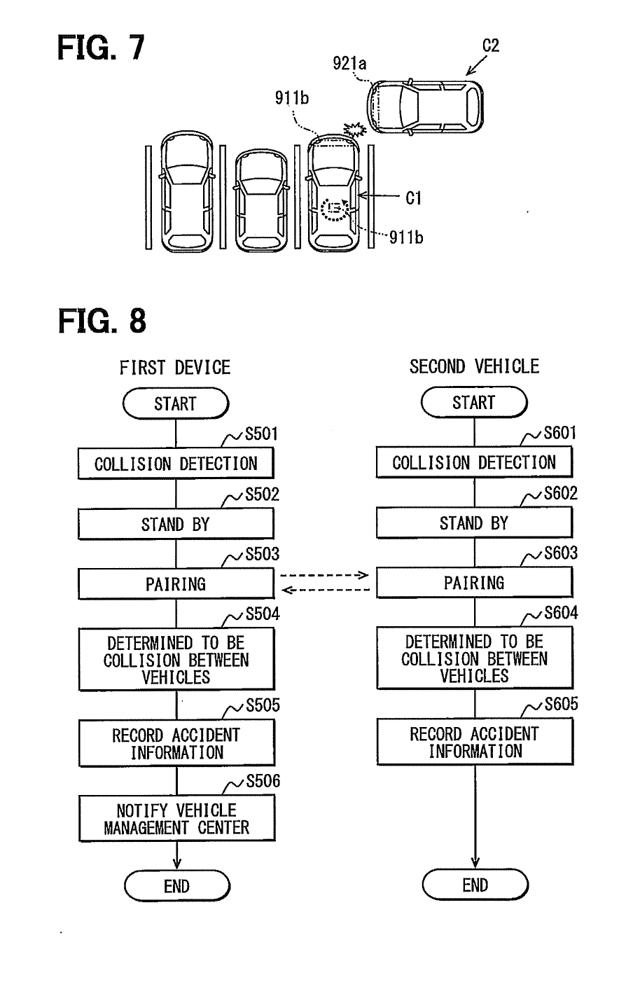

A flow of control in the vehicle collision detection system of the fourth embodiment will be described from the first vehicle C1 side. As illustrated in FIGS. 7 and 8, when the second vehicle C2 in a traveling state collides with the first vehicle C1 in a stopped state, a collision with something is detected on the first vehicle C1 side (S501) as a result of a measurement value by the collision detection sensor 911 exceeding a predetermined threshold value, and a collision with something is detected as well on the second vehicle C2 side (S601) as a result of a measurement value by the collision detection sensor 921 in the second vehicle C2 exceeding a predetermined threshold value. Since the first vehicle C1 is in a stopped state, the airbag ECU 3 operates based on the detection results by the pressure sensor 911a, the G-sensor 911c and the yaw rate sensor 911b. Since the second vehicle C2 is in a traveling state, the airbag ECU 30 operates based on a detection result by the pressure sensor 921a.

After standing by for a predetermined time (approximately one second) (S502, S602) on the vehicle C1 side and on the vehicle C2 side, pairing is performed (S503, S603). To explain the pairing, firstly, the wireless communication parts 912, 922 transmit the pairing request signals within a predetermined range. The pairing request signal may be transmitted continuously for a predetermined time (period) immediately after detection of the collision until reception of the pairing response signal, or may be transmitted after a standby time after the collision detection. The former is employed for the present embodiment. Upon reception of the pairing request signal through short distance communication, the wireless communication part 912 (922) confirms with the airbag ECU 3 (30) whether the collision has occurred and transmits the pairing response signal within a predetermined range. Upon reception of the pairing response signal by the wireless communication part 922 (912), authentication is satisfied through the pairing. In the present embodiment, the pairing response signal is transmitted by one of the wireless communication parts 912, 922 that has earlier received the pairing request signal. The unique informations on their own vehicles are exchanged through the pairing.

Upon the satisfaction of authentication through the pairing, the collision determination parts 913, 923 determine that their own vehicles have had a collision with a vehicle (S504, S604). If the authentication through the pairing is not satisfied within a predetermined time, the collision determination parts 913, 923 determine that the object for the collision is not a vehicle, to end the processing.

If the collision determination parts 913, 923 determine that their own vehicles have had a collision with a vehicle, information about the accident collected by the collision determination parts 913, 923 (airbag ECU 3) and this accident information is recorded on the event data recorders 914, 924 (S505, S605). As described above, the accident information includes, for example, a position of an accident occurrence site, images before and after the accident occurrence, a collision position and a rate of acceleration at the time of the collision, a vehicle speed, a braking signal, a steering angle signal, and unique information about the counterpart vehicle. Then, at least one (collision determination part 913 on the stopped vehicle side in this embodiment) of the collision determination parts 913, 923 notifies the public institution of the accident along with the accident information (S506).

In the fourth embodiment, when a collision occurs between vehicles, the pairing is performed after detection of the collision, and upon the satisfaction of authentication, whether the collision occurs between vehicles is determined. Accordingly, there can be accurately detected the fact that the collision has occurred and that the object for the collision is a vehicle. The collision detection devices 91, 92 can operate even if the corresponding vehicles are in a stopped state, and by operating them despite the stopped state, their collision with a vehicle can be detected even when a driver is away from the vehicle. As a result, even in a case of a hit-and-run accident, for example, the collision is detected through the pairing by a vehicle which has been involved in a hit-and-run accident. Thus, various responses can be made such as acquisition of unique information about the counterpart vehicle, or notification to a predetermined institution (e.g., vehicle management center). Whether an owner of the vehicle is away or not, and whether the vehicle is in a stopped state or in a traveling state, if the vehicles collide with each other and the pairing is satisfied, unique information is exchanged between the vehicles and automatic notification is given. In the fourth embodiment, a prompt response such as identification of a counterpart in a hit-and-run accident and notification thereof can be made, and a hit-and-run accident can be inhibited because detection and notification are possible despite a stopped state of the vehicle.

Moreover, because the wireless communication parts 912, 922 enable communication (short distance communication) within a predetermined range, and a communication range is limited, a communication with a vehicle having another accident can be restricted. In the fourth embodiment, since the electricity is supplied to the collision detection devices 91, 92 by the auxiliary batteries 916, 926, the main battery is not consumed even if the vehicle is in a stopped state, so that the main battery can be prevented from running out.

The present disclosure is not limited to the above-described embodiment. For example, the collision detection devices 91, 92 may be designed to be supplied with electricity from the main batteries of the vehicles. Therefore, the collision detection devices 91, 92 do not need to include the auxiliary batteries 916, 926. The main battery is a battery for supplying electricity used at the time of start-up of an engine, for example. The collision detection devices 91, 92 may be designed to be supplied with electricity by the main batteries at the time of vehicle traveling and by the auxiliary batteries 916, 926 at the time of vehicle stop.

Furthermore, even in a case where the vehicles collide at the time of traveling, the collision detection devices 91, 92 can recognize that a collision has occurred between the vehicles by performing the pairing after the collision, and automatic notification can be given even if a driver of the vehicle is unconscious. In addition, the above-described hit-and-run (vehicle running over a pedestrian) determination part 26 can serve as a hit-and-run (wrecking a vehicle) determination part, and can be set to detect a hit-and-run accident (wrecking a vehicle) with the idea (e.g., whether or not the communication between the wireless communication parts 912, 922 is possible after the pairing is satisfied) similar to the hit-and-run (vehicle running over a pedestrian) detection in the third embodiment. The pressure sensor 911a may be disposed in a bumper of the vehicle at its rear part in addition to a front part of the vehicle.

To sum up, the pedestrian collision detection system, the pedestrian collision notification system, and the vehicle collision detection system of the above embodiments can be described as follows.

A pedestrian collision detection system includes a mobile communication device 1 and a pedestrian collision detection device 2. The mobile communication device 1 is owned by a pedestrian and includes a mobile-side impact detection part 11, an impact record part 12, and a short distance communication part 15. The mobile-side impact detection part 11 is configured to detect a collision between a vehicle and the pedestrian. The impact record part 12 is configured to, when the mobile-side impact detection part 11 detects the collision, hold a result of the detection for a predetermined time. The short distance communication part 15 is configured to enable wireless communication within a predetermined range. The pedestrian collision detection device 2 is disposed in the vehicle and includes a vehicle-side collision detection part 21 and a wireless communication part 22. The vehicle-side collision detection part 21 is configured to detect the collision between the vehicle and the pedestrian, or a crash between the vehicle and an object. The wireless communication part 22 is configured to enable wireless communication within a predetermined range. The wireless communication part 22 and the short distance communication part 15 perform mutual authentication through pairing when the vehicle-side collision detection part 21 detects the collision and the result of the detection is held by the impact record part 12. The pedestrian collision detection device 2 further includes a vehicle-side collision determination part 23 configured to determine that the vehicle and the pedestrian have collided when the mutual authentication through pairing is satisfied between the wireless communication part 22 and the short distance communication part 15.

A pedestrian collision notification system includes a mobile communication device 1 and a pedestrian collision detection device 2. The mobile communication device 1 is owned by a pedestrian and includes a mobile-side impact detection part 11, an impact record part 12, and a short distance communication part 15. The mobile-side impact detection part 11 is configured to detect a collision between a vehicle and the pedestrian. The impact record part 12 is configured to, when the mobile-side impact detection part 11 detects the collision, hold a result of the detection for a predetermined time. The short distance communication part 15 is configured to enable wireless communication within a predetermined range. The pedestrian collision detection device 2 is disposed in the vehicle and includes a vehicle-side collision detection part 21 and a wireless communication part 22. The vehicle-side collision detection part 21 is configured to detect the collision between the vehicle and the pedestrian, or a crash between the vehicle and an object. The wireless communication part 22 is configured to enable wireless communication within a predetermined range. The wireless communication part 22 and the short distance communication part 15 perform mutual authentication through pairing when the vehicle-side collision detection part 21 detects the collision and the result of the detection is held by the impact record part 12. The pedestrian collision detection device 2 further includes a vehicle-side collision determination part 23 and a notification part 25. The vehicle-side collision determination part 23 is configured to determine that the vehicle and the pedestrian have collided when the mutual authentication through pairing is satisfied between the wireless communication part 22 and the short distance communication part 15. The notification part 25 is configured to notify a public institution about the collision when the vehicle-side collision determination part 23 determines that the vehicle and the pedestrian have collided.

As a result of these configurations, when the mutual recognition through the pairing between the mobile communication device 1 and the vehicle-side can be made, it is determined that the collision is a collision with a pedestrian. Accordingly, the collision with the pedestrian can be detected with a high degree of accuracy. By these configurations, a false report at the time of the collision can be limited.

In addition, a vehicle collision detection system includes a first collision detection device 91 and a second collision detection device 92. The first collision detection device 91 is disposed in a first vehicle C1 and includes a first collision detection part 911 and a first wireless communication part 912. The first collision detection part 911 is configured to detect a collision. The first wireless communication part 912 is configured to enable wireless communication within a predetermined range. The second collision detection device 92 is disposed in a second vehicle C2 and includes a second collision detection part 921 and a second wireless communication part 922. The second collision detection part 921 is configured to detect a collision. The second wireless communication part 922 is configured to enable wireless communication within a predetermined range. The first wireless communication part 912 and the second wireless communication part 922 perform mutual authentication through pairing when the first collision detection part 911 and the second collision detection part 921 detect the collision. Each of the first collision detection device 91 and the second collision detection device 92 further includes a collision determination part 913, 923 that is configured to determine that the first vehicle C1 and the second vehicle C2 have collided, with each other when the mutual authentication through pairing is satisfied between the first wireless communication part 912 and the second wireless communication part 922.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A pedestrian collision detection system comprising:
a mobile communication device that is owned by a pedestrian and includes:
a mobile-side impact detection part that is configured to detect a collision between a vehicle and the pedestrian;
an impact record part that is configured to, when the mobile-side impact detection part detects the collision, hold a result of the detection for a predetermined time; and
a short distance communication part that is configured to enable wireless communication within a predetermined range; and
a pedestrian collision detection device that is disposed in the vehicle and includes:
a vehicle-side collision detection part that is configured to detect the collision between the vehicle and the pedestrian, or a crash between the vehicle and an object; and
a wireless communication part that is configured to enable wireless communication within a predetermined range, wherein:
the wireless communication part and the short distance communication part perform mutual authentication through pairing when the vehicle-side collision detection part detects the collision and the result of the detection is held by the impact record part; and
the pedestrian collision detection device further includes a vehicle-side collision determination part configured to determine that the vehicle and the pedestrian have collided when the mutual authentication through pairing is satisfied between the wireless communication part and the short distance communication part.

2. The pedestrian collision detection system according to claim 1, wherein:
when the vehicle-side collision detection part detects the collision, the wireless communication part transmits a pairing request signal within the predetermined range; and
when the short distance communication part receives the pairing request signal and the result of the detection is held by the impact record part, the short distance communication part transmits a pairing response signal to the wireless communication part.

3. The pedestrian collision detection system according to claim 1, wherein:
when the mobile-side impact detection part detects the collision, the short distance communication part transmits a pairing request signal within the predetermined range; and
when the wireless communication part receives the pairing request signal and in a state where the vehicle-side collision detection part detects the collision, the wireless communication part transmits a pairing response signal to the short distance communication part.

4. The pedestrian collision detection system according to claim 1, wherein the mobile-side impact detection part includes:
a gravity (G)-sensor; and
a mobile-side collision determination part that is configured to determine that the vehicle and the pedestrian have collided when a measurement value by the G-sensor exceeds a predetermined threshold value.

5. The pedestrian collision detection system according to claim 1, wherein the wireless communication part transmits unique information on the vehicle to the short distance communication part after the mutual authentication through pairing.

6. The pedestrian collision detection system according to claim 5, wherein the mobile communication device further includes a sound/data communication part that is configured to notify a public institution about the collision together with the unique information on the vehicle which is obtained from the wireless communication part.

7. The pedestrian collision detection system according to claim 1, wherein the short distance communication part transmits unique information on the mobile communication device to the wireless communication part after the mutual authentication through pairing.

8. The pedestrian collision detection system according to claim 7, wherein the pedestrian collision detection device further includes:
an event data recorder that is configured to record the unique information on the mobile communication device which is obtained by the wireless communication part; and
a notification part that is configured to notify a public institution about the collision together with the unique information on the mobile communication device when the unique information on the mobile communication device is recorded on the event data recorder.

9. The pedestrian collision detection system according to claim 8, wherein the notification part notifies the public institution further about at least one of rudder angle information concerning the collision, vehicle speed information concerning the collision, brake information concerning the collision, and an image related to the collision.

10. The pedestrian collision detection system according to claim 8, wherein:
the pedestrian collision detection device further includes a vehicle-side position information acquisition part that is configured to acquire position information on the vehicle in which the pedestrian collision detection device is disposed;
the mobile communication device further includes a mobile-side position information acquisition part that is configured to acquire position information on the mobile communication device;
the unique information on the mobile communication device includes the position information acquired by the mobile-side position information acquisition part;
the event data recorder records an accident occurrence location that is determined based on the position information obtained through pairing from the vehicle-side position information acquisition part and the mobile-side position information acquisition part; and
the notification part notifies the public institution further about the accident occurrence location.

11. The pedestrian collision detection system according to claim 10, wherein the pedestrian collision detection device further includes a hit-and-run determination part that is configured to determine that there is a possibility of a hit-and-run accident when a position of the vehicle that is indicated by the position information acquired by the vehicle-side position information acquisition part is separated from the accident occurrence location recorded on the event data recorder by a predetermined distance or longer within a predetermined time after the vehicle-side collision determination part determines that the vehicle and the pedestrian have collided.

12. The pedestrian collision detection system according to claim 10, wherein the pedestrian collision detection device further includes a hit-and-run determination part that is configured to determine that there is a possibility of a hit-and-run accident when communication cannot be made between the wireless communication part and the short distance communication part within a predetermined time after the vehicle-side collision determination part determines that the vehicle and the pedestrian have collided.

13. The pedestrian collision detection system according to claim 1, wherein the mobile communication device further includes a sound/data communication part that is configured to notify a public institution about the collision when the mutual authentication through pairing is satisfied between the wireless communication part and the short distance communication part.

14. A pedestrian collision notification system comprising:
a mobile communication device that is owned by a pedestrian and includes:
a mobile-side impact detection part that is configured to detect a collision between a vehicle and the pedestrian;
an impact record part that is configured to, when the mobile-side impact detection part detects the collision, hold a result of the detection for a predetermined time; and
a short distance communication part that is configured to enable wireless communication within a predetermined range; and
a pedestrian collision detection device that is disposed in the vehicle and includes:
a vehicle-side collision detection part that is configured to detect the collision between the vehicle and the pedestrian, or a crash between the vehicle and an object; and
a wireless communication part that is configured to enable wireless communication within a predetermined range, wherein:
the wireless communication part and the short distance communication part perform mutual authentication through pairing when the vehicle-side collision detection part detects the collision and the result of the detection is held by the impact record part; and
the pedestrian collision detection device further includes:
a vehicle-side collision determination part configured to determine that the vehicle and the pedestrian have collided when the mutual authentication through pairing is satisfied between the wireless communication part and the short distance communication part; and
a notification part configured to notify a public institution about the collision when the vehicle-side collision determination part determines that the vehicle and the pedestrian have collided.

15. The pedestrian collision notification system according to claim 14, wherein the notification part notifies the public institution further about at least one of position information on the vehicle related to the collision, rudder angle information concerning the collision, vehicle speed information concerning the collision, brake information concerning the collision, and an image related to the collision.

16. A vehicle collision detection system comprising:
a first collision detection device that is disposed in a first vehicle and includes:
a first collision detection part configured to detect a collision; and
a first wireless communication part configured to enable wireless communication within a predetermined range; and
a second collision detection device that is disposed in a second vehicle and includes:
a second collision detection part configured to detect a collision; and
a second wireless communication part configured to enable wireless communication within a predetermined range, wherein:
the first wireless communication part and the second wireless communication part perform mutual authentication through pairing when the first collision detection part and the second collision detection part detect the collision; and
each of the first collision detection device and the second collision detection device further includes a collision determination part that is configured to determine that the first vehicle and the second vehicle have collided with each other when the mutual authentication through pairing is satisfied between the first wireless communication part and the second wireless communication part.

17. The vehicle collision detection system according to claim 16, wherein:
the first wireless communication part transmits unique information on the first vehicle to the second wireless communication part after the mutual authentication through pairing; and
the second wireless communication part transmits unique information on the second vehicle to the first wireless communication part after the mutual authentication through pairing.

18. The vehicle collision detection system according to claim 17, wherein each of the first collision detection device and the second collision detection device further includes:
an event data recorder configured to record the unique information received after the mutual authentication through pairing; and
a notification part configured to notify a public institution about the collision between the first vehicle and the second vehicle together with the unique information when the unique information is recorded on the event data recorder.

19. The vehicle collision detection system according to claim 18, wherein the notification part notifies the public institution further about at least one of vehicle position information related to the collision, rudder angle information concerning the collision, vehicle speed information concerning the collision, brake information concerning the collision, and an image related to the collision.

20. The vehicle collision detection system according to claim 16, wherein each of the first collision detection device and the second collision detection device further includes an auxiliary battery.
